(19) United States
(12) Patent Application Publication
(10) Pub. No.: US 2024/0331543 A1
(43) Pub. Date: Oct. 3, 2024

(54) Pedestrian crosswalk alert system

(71) Applicants: Ryan Leo Groszmann, Belmont, MA (US); Daniel Groszmann, Belmont, MA (US)

(72) Inventors: Ryan Leo Groszmann, Belmont, MA (US); Daniel Groszmann, Belmont, MA (US)

(21) Appl. No.: 18/190,961

(22) Filed: Mar. 27, 2023

(51) Int. Cl. G08G 1/16; G08G 1/04; G08G 1/095

(52) U.S. Cl. CPC G08G 1/166; G08G 1/04; G08G 1/095

(57) ABSTRACT

This invention relates to a system to alert drivers and bicyclists of a pedestrian crossing in a crosswalk in nighttime or dark conditions. It uses road markings consisting of a fluorescent pigment installed on a pedestrian crossing. A sensor detects the presence of a pedestrian intending to cross at the crosswalk and then an ultraviolet light source, not visible to the pedestrian, is activated to irradiate the fluorescent road markings, which then emit visible light seen by the oncoming vehicle. The system communicates with a paired and identical alert system on the other side of the crosswalk to illuminate the road markings on both sides of the road and account for pedestrian crossing from either side.

### PRIOR ART

### U.S. Patent Documents

| | | | |
|---|---|---|---|
| 3,996,556 | A | April 1974 | Eigenmann |
| 5,406,276 | A | July 1992 | Ogle |
| 5,734,339 | A | September 1996 | Ogle |
| 9,976,714 | B2 | May 2018 | Karl J. L. et al. |
| 11,600,175 | B2 | March 2023 | Yurika et al. |
| 2007/0012237 | A1 | July 2005 | Nielsen |
| 2012/0301657 | A1 | November 2012 | Stein |
| 2022/0412519 | A1 | December 2022 | Eric et al. |
| 2022/0270475 | A1 | August 2022 | Shin et al. |
| 2022/0195679 | A1 | June 2022 | Ganesh P. D. et al. |
| 2022/0076572 | A1 | March 2022 | Yurika et al. |
| 2023/0019735 | A1 | January 2023 | Shin et al. |

### Foreign Patent Documents

JP 3 833 001 B2 4/1999

### BACKGROUND OF THE INVENTION

This invention relates to the field of pedestrian crosswalk alert systems. More specifically, it relates to a system for alerting drivers that a pedestrian is in or about to be in a crosswalk. Conventionally, the location of a pedestrian crossing can be recognized by white painted markings or zebra markings. Sometimes these markings are painted with the inclusion of glass beads to reflect car headlights at night and better illuminate the crosswalk. In addition, overhead street lighting may increase the reflection of the crosswalk markings. The location of pedestrian crossings that are not located at a traffic stop light occasionally have a reflective street sign to better identify the crosswalk to oncoming vehicles. Furthermore, there are also crosswalk signs that flash lights or beacons when actuated by the pedestrian, to alert oncoming vehicles that a pedestrian is intending to cross the road.

There are crosswalk warning systems that automatically detect pedestrians at a crosswalk and activate a light or laser that is aimed across the intersection, so that an approaching driver might see the light beam and be warned of the pedestrian's presence. The lights are supported by poles located on the sidewalks. This lighting system will be difficult for an oncoming vehicle to notice if it's in an area where there are already other conventional light sources.

There are also warning systems that illuminate a crosswalk when an oncoming vehicle is detected, even if no pedestrian is in the crosswalk. This makes this type of system very similar to a continuously blinking crosswalk sign that drivers get accustomed to and ignore, as it frequently becomes a false signal that a pedestrian is crossing. This system typically requires an overhead support structure to illuminate the entire crosswalk, which makes this installation expensive and unlikely to be used widely.

Visibility of the crosswalk by a driver at night depends mostly on the retroreflection of the road markings by the car headlights. However, most drivers do not stop at a crosswalk where there is no traffic light unless they become aware of a pedestrian in the crosswalk. There are many traffic accidents because a driver does not realize a pedestrian is crossing the road at night. This becomes even more difficult with adverse weather such as rain, fog, and snow that reduces visibility of crosswalks and pedestrians.

Furthermore, the active pedestrian crossing signs with blinking lights or beacons can occasionally be difficult for drivers to notice because they are typically positioned on the side of the roads. Occasionally, these blinking lights or beacons, and even the pedestrians, are blocked from view by the drivers with structures, other vehicles, and/or vegetation on the sides of the roads. Crossing lights embedded in roadways have also been proposed but are considered unreliable due to the wear and tear of traffic passing over. In addition, these systems tend to be very expensive to install and therefore are not widely used, but instead, only used in highest risk areas.

There is prior art of a road marking material that emits visible light by irradiating the road marking material blended with a fluorescent pigment or a phosphorescent pigment with a UV lamp. There is also prior art of a system with sensors that recognize pedestrians in a crosswalk but also recognizes oncoming cars to illuminate the crosswalk. However, these systems do not adequately handle pedestrians crossing from both sides of a road. They also activate when an oncoming vehicle such as a car or truck is detected even if no pedestrian is in the crosswalk. As such, these systems may trigger with no pedestrian intending to use the crosswalk and so drivers will learn to ignore this system. This system may not handle situations with pedestrians crossing crosswalks from opposite sides, or from multiple sides if there is an island, for example, in the middle of the crosswalk. These systems will also require significant expense to install and service.

### SUMMARY OF THE INVENTION

Therefore, the present invention has solved the above-mentioned problem by providing a road marking material containing fluorescent pigments on the pedestrian crossing and/or temporary yield line adjacent to the crosswalk and a sensor to automatically detect a pedestrian approaching the crosswalk from either side of the road. Upon detection of a pedestrian, the system illuminates an ultraviolet LED source that is directed at the fluorescent road markings from the side of the road for a prescribed amount of time to alert oncoming drivers and bicyclists that a pedestrian is intending to cross. The controller wirelessly communicates with a paired controller on the opposite side of the road to illuminate the UV-reactive pigments on the opposite side of the crosswalk. Therefore, this system can illuminate a complete crosswalk yield line, such as a shark-tooth pattern, from both sides of the pedestrian crossing without requiring expensive installations such as overhead structures. Also, by not requiring detection of the oncoming vehicle, this system will be more reliable by always illuminating the crosswalk and temporary yield line when a pedestrian or pedestrians is/are crossing. This invention will be easy and low-cost to deploy in mid-block crosswalks or any pedestrian crossing where there is not an existing traffic light. This invention is not intended for high-speed roads as the road markings cannot be seen from a very far distance. This invention will be more effective than current solutions, such as flashing beacons on the sides of roads, when the vehicles are closer to the crosswalk, as drivers tend to be looking straight ahead and not at the sides of the road where the pedestrians and the beacons are located.

The present invention is configured as the following system. A pedestrian crossing is provided with a road marking material containing at least a fluorescent pigment that is applied on the road surface along the crosswalk to create a visual indicator of a temporary yield line m 3 adjacent to the traditional crosswalk markings. The fluorescent pigment is selected to be ultraviolet (UV) reactive. That is, it absorbs light rays in the ultraviolet spectrum and emits in the visible spectrum. The system includes a support pole with a sensor erected on the side of the road adjacent to the pedestrian crossing and the temporary yield line for detecting pedestrians. An ultraviolet light source is attached to the support pole and aimed toward the road surface where the fluorescent road marking was applied. The system includes a controller for communicating with the pedestrian sensor and with the UV light source. The controller includes a timing capability to illuminate the UV light source for a prescribed amount of time. The controller also includes logic to allow the UV light source to blink on and off, thereby making it more obvious to oncoming traffic. The controller may also have logic to only activate in low-light conditions and save energy. The system includes another support pole with a pedestrian sensor and a UV light source, together with a controller on the opposite side of the crosswalk. The controllers have wireless communication capabilities to trigger the UV light source to illuminate on one side of the road when a pedestrian is detected on the opposite side. This allows a system to illuminate a temporary yield line from both sides of the crosswalk and be aimed at offset yield lines that are positioned ahead of the crosswalk when viewed from the traffic direction for two-way roads. The system is powered by solar panels on top of the support pole, allowing it to be installed virtually anywhere along a road. The support pole may also have a button to manually activate the UV light source. The support pole may also have signage to indicate it's a pedestrian crossing. The system may also be combined with more traditional crosswalk warning systems such as flashing beacons that can be seen from further away.

According to the present invention, a road marking paint or material containing a fluorescent pigment is preliminarily applied to a pedestrian crossing in such a way as it would appear as a yield line in front of the pedestrian crossing for oncoming vehicles. A fluorescent light-emitting effect can be obtained by a UV-reactive pigment that absorbs in a wavelength range of about 300 nm to 400 nm and then simultaneously emits in the visible light spectrum of around 400 nm to 700 nm. Furthermore, the fluorescent pigment is selected to be a very noticeable color when it emits in the visible spectrum such as red in the 625 nm to 750 nm. Some available pigments are white or clear when not excited by UV rays. The ideal pigment is one that has a very discernible change when illuminated by UV rays so that it is clearly visible at night. In addition, the road marking material can be mixed and dispersed with glass beads for augmented night visibility.

The ultraviolet light source on the support pole is aimed to cover the pedestrian crossing where the fluorescent road marking material was applied but only through a little over half the crossing distance of the crosswalk as there is another UV light source on the opposite side of the crosswalk that is aimed to cover the other half of the crosswalk fluorescent road markings. The UV light source is ideally positioned no higher than about 1 meter, so the emitted UV light is not directed at pedestrian's eyes. The UV light source is ideally on a moveable joint so its aim can be adjusted during installation. The UV light source can be a black light that cuts off any visible light from the UV source. It can be based on light-emitting diode (LED) technology and have a lens and mirror to aim and focus the rays of UV light to a very specific area when the fluorescent road markings are applied.

The UV light source is not activated until a pedestrian approaches the pedestrian crossing, thereby illuminating the temporary yield line and alerting oncoming vehicles that a pedestrian is about to cross the road. The presence of the pedestrian by the start of the crosswalk is detected by a proximity sensor attached to the support pole. The sensor can be an ultrasound-based technology that emits a sound wave at a frequency inaudible to humans and animals. A person or persons in vicinity of the sensor create a return sound wave that bounces back. The time between the ultrasound wave being emitted until a return signal being detected can be used to estimate the distance to the pedestrian. The controller can be programmed to activate the UV light source when pedestrians are at specified distance such as less than 3 meters away if the crosswalk is 3 meters wide. The proximity sensor should be about 1 meter high to detect pedestrians, people in wheelchairs, children old enough to walk, etc. A manual override button can be next to the proximity sensor to turn the UV light source on manually.

When a pedestrian is detected, the controller activates the UV light source for a prescribed amount of time using a timer. The time is adjustable via settings on the controller to handle different length crosswalks, so pedestrians have enough time to cross the crosswalk, similar to timed crossing lights at a typical traffic light. The UV light source is programmed to blink on and off to increase detectability of the fluorescent temporary yield line, with the blinking frequency and duration programmable as well. The controller also transmits a wireless signal to the paired system on the opposite side of the crosswalk at the same time that the controller turns on the UV light source. The paired controller on the second support pole will receive the wireless signal from the first controller and then activate its own UV light source to illuminate the fluorescent road markings from its side of the crosswalk, so both light sources are activated at nearly the same time or with some programmed delay. Alternatively, the second controller detects a pedestrian and signals the first controller so both UV light sources are turned on. The two controllers on separate support poles are programmed to be paired during installation or during manufacturing. Multiple paired systems can be deployed in a location without interfering with each other using existing radio frequency techniques.

As the system is powered by a small solar array that stores energy in a rechargeable battery, the crosswalk alert system will have an ambient light detector so the controller can turn the system off when there is sufficient daylight that the fluorescent road markings will not be visible to drivers. This will allow enough energy to be stored during the day that the system will operate all night without running out of energy.

The support pole can include a pedestrian crossing sign as well as more traditional blinking lights or flashing beacons to further inform drivers and pedestrians of the crosswalk. The support pole can be affixed to the ground adjacent to the crosswalk. Alternatively, the system minus a support pole can be added to existing crosswalk signage, further reducing the cost. The pedestrian crossings can include raised crossings where the temporary yield lines can be painted on the ramps to the raised crossings. This would also increase their visibility to oncoming vehicles.

### BRIEF DESCRIPTION OF DRAWINGS

FIG. 1 is a perspective view showing an embodiment of the present invention.

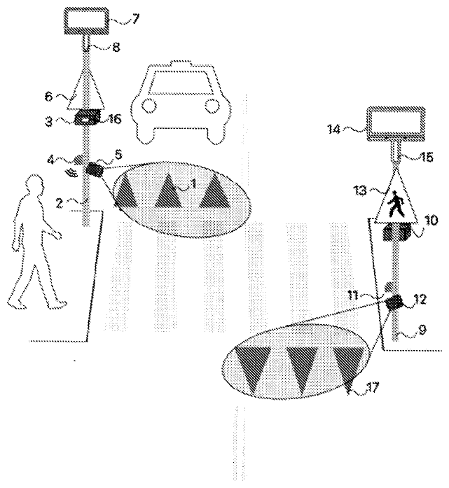

### DETAILED DESCRIPTION OF THE INVENTION

The preferred embodiments of the present invention are described below with reference to the drawing.

In the drawing, a road marking 1 made of a fluorescent pigment compound is applied at a pedestrian crossing as part of the system installation. The road marking can have the shape of yield symbols, as shown. A support pole 2 is mounted on the first side boundary of the road, adjacent to the crosswalk. A controller 3 is attached to the support pole. The controller is connected to a proximity sensor 4 and to a UV light source 5. A pedestrian crossing sign 6 is also mounted on the support pole. Solar panels 7 are mounted on the top of the support pole, which provide power to rechargeable batteries 8 that in turn power the controller, sensor, and UV light source. A duplicate support pole 9 is on the opposite side of the crosswalk on a second side boundary with its own controller 10, proximity sensor 11, UV light source 12, crossing sign 13, solar panels 14, and rechargeable batteries 15. A manual override button 16 is also provided for a pedestrian to use if the proximity sensor is not functional or if the timer has timed-out. The controllers also contain an ambient light sensor to enable operation of the system only when there are low-light conditions, to save on stored energy. When a pedestrian is detected by a proximity sensor 4 or 11 on either side of the crosswalk in low-light conditions, both UV light sources 5 and 12 illuminate the fluorescent road markings 1 and 17 from both sides of the crosswalk, via the controllers that are in wireless communication with each other, having been paired. The controllers 3 and 10 have a built-in timer and logic to make the UV light source illuminate and blink on and off for a prescribed amount of time, and then automatically shut off the UV light source. The system remains operational during the entire period of low-light conditions. The solar panels recharge the batteries during daytime while not in operation.

The road marking materials 1 and 17 are a paint or other compound containing a fluorescent pigment, and when irradiated with UV rays in low-light conditions such as nighttime, dusk, dawn, fog, rain, snow, etc., it emits visible light to alert oncoming drivers that a pedestrian is on the crosswalk. The UV light source emits in the 315 nm to 450 nm wavelength. Preferably, the UV light source is in the 365 nm range using LEDs, so the UV rays are not visible to people, do not create shadows, and consume very low power. The UV light source may contain a mirrored back-surface and a lens to assist in directing most of the UV rays towards the crosswalk. The fluorescent pigment emits visible light. Different color pigments can be chosen such that temporary yield line road markings appear white or clear when not illuminated by UV light source and appear red or yellow when excited by UV rays. Drivers approaching the crosswalk will be alerted by the yield lines lighting up in dark conditions when a pedestrian is intending to cross the road. Use of the UV light source, including the use of a black light as the UV light source, also has the advantage of making certain clothing materials very bright as well at night, which also helps with alerting drivers. The fluorescent pigment can optionally be used on clothing, dog leashes, backpacks and other apparel to fluoresce automatically when crossing these crosswalks. The system can also be used to illuminate the white patterns of the crosswalk as well to make them more visible in dark conditions.

The road marking material 1 may have glass beads or rough sand applied on the surface, which may aid in more fluorescent pigment attaching to the road surface and therefore more visible light emissions. The rough surface may also reduce slippery conditions when wet from precipitation. The preferred embodiment will use a pattern of yield signs on the temporary yield line that emit in the red color and a pattern of yellow lines in between the white crosswalk patterns. The temporary yield line should be in front of the crosswalk when viewed from oncoming vehicles. In a two-way road, the temporary yield lines would be offset on either side of the crosswalk.

The UV light source is mounted on a joint on the support pole so it can be properly aimed at the fluorescent yield line road markings during the installation. Some embodiments may use a plurality of UV light sources to adequately illuminate the fluorescent road markings. For an example road that is approximately 6 meters wide with about a 2-meter-wide crosswalk, this invention would use about a 4-meter-high support pole on both sides of the roadway. The proximity sensor on each support pole would be configured to detect a pedestrian that is within about 3 meters distance, which would adequately sense the presence of any pedestrian intending to cross the road at the crosswalk. The UV light source on each side would be configured to illuminate just over 3 meters with some overlap in the middle, which would cover the full 6-meter length of the crosswalk. The proximity sensor would be positioned 1 meter high, facing parallel to the road. The UV light source would be positioned facing the road and less than 1 meter high, angled downward. The typical timer for this crosswalk distance of 3 meters is 6 seconds given a standard walking speed of 1 m/s. The blinking pattern would typically be 1 second on and 1 second off that repeat for a total of 6 seconds. The system is designed so that any additional pedestrians detected on either side of the road would restart the timers.

The type of proximity sensor used is an ultrasonic emitter-detector that can detect the distance to a pedestrian. These types of sensors are very reliable and have an emitter and a detector. The emitter sends an ultrasonic signal and waits for the echo or return signal that is received by the detector. This can be used to determine the distance to any object in proximity to the sensor as speed of sound in air times the transit time of the ultrasonic signal transmission to receiving the echo back divided by two. Since the speed of sound in air is temperature dependent, a temperature sensor can be included in the controller to increase the accuracy of the proximity sensor. Alternative proximity sensors include infrared sensors as well as thermal cameras.

The operation of the crosswalk alert system is summarized as follows:
(1) the system is installed in a crosswalk, including painting or installing the temporary yield line with a fluorescent pigment that transitions from clear to red when exposed to a UV light source. There are at least 2 support poles, each installed on a first side boundary and a second side boundary of the crosswalk;
(2) in the evening, the onboard ambient light sensor in each controller enables the system to be operational;
(3) pedestrian proximity sensors will be active, ready to detect any pedestrian in front of the crosswalk on a first side boundary or second side boundary of the road;
(4) a pedestrian approaches the pedestrian crossing on a first side boundary of the crosswalk;
(5) the proximity sensor detects a pedestrian on a first side boundary of the crosswalk;
the UV LED light source on a first side boundary of the crosswalk is illuminated; and
the controller wirelessly communicates with the paired controller on a second side boundary of the crosswalk to illuminate that UV light source;
a timer in each controller keeps the UV light sources illuminated on a first side boundary and a second side boundary of the crosswalk, blinking them on and off for the prescribed amount of time, before shutting off the UV light sources;
(6) repeating (3) to (5).
(7) the system is operational until dawn and at that point is no longer active. Solar panels recharge the batteries for the next operational cycle.

While only certain features of the invention have been illustrated and described herein, many modifications and changes will occur to those skilled in the art. It is, therefore, to be understood that the appended claims are intended to cover all such modifications and changes as fall within the true spirit of the invention.

The invention claimed is:

1. A crosswalk alert system for giving visual indication to vehicular traffic on a selected road that at least one pedestrian is about to cross or is within a crosswalk on the selected road, the crosswalk terminating at a first and a second side boundary of the selected road, said crosswalk alert system comprising:
a pedestrian crossing with a temporary yield line identified with a road marking material containing at least a fluorescent pigment that is ultraviolet-reactive;
a controller interfaced with at least one ultraviolet light source and at least one proximity sensor;
the proximity sensor enabled to detect a person approaching a pedestrian crossing from a first side boundary of the road. When the proximity sensor is triggered, the controller turns on the at least one ultraviolet light source for a prescribed length of time;
the controller in wireless communication with the paired controller on at least a second side boundary of the road; and
the paired controller configured to turn on the at least one ultraviolet light source adjacent to the at least a second side boundary of the road for the prescribed length of time and then turning it off.

2. The crosswalk alert system according to claim 1, wherein the ultraviolet light source is configured to blink on and off.

3. The crosswalk alert system according to claim 1, wherein the proximity sensor comprises an ultrasonic emitter-detector.

4. The crosswalk alert system according to claim 1, wherein the proximity sensor comprises an infrared sensor.

5. The crosswalk alert system according to claim 1, wherein wireless communication between controllers is RF-based.

6. The crosswalk alert system according to claim 1, wherein the controller comprises an ambient light detector to determine low-light conditions.

7. The crosswalk alert system according to claim 1, wherein the controller comprises a manual button configured to bypass the proximity sensor to activate the alert system.

8. The crosswalk alert system according to claim 1, wherein the controller, the at least one proximity sensor, and the at least one ultraviolet light source are partially disposed on at least one support pole.

9. The crosswalk alert system according to claim 1, wherein the power source for the controller, the at least one proximity sensor, and the at least one ultraviolet light source is a solar array with rechargeable battery.

10. The crosswalk alert system according to claim 1, wherein the fluorescent pigment emits visible light when excited by ultraviolet energy in the 315 nm to 450 nm wavelength range.

11. The fluorescent pigment according to claim 10, comprising of different pigments in the road markings to emit visible light comprising of more than one color.

12. A method of alerting a driver in a vehicle on a selected road of a pedestrian in a crossing ahead, the crosswalk being adapted to contain road markings that emit visible light that can be seen by the approaching driver in low-light conditions, the method comprising:
at least one road marking material comprising of a pigment adapted to fluoresce when exposed to ultraviolet light;
at least one proximity sensor adapted to detect the presence of a pedestrian adjacent to the crosswalk on a first side boundary of the road;
at least one ultraviolet source of light adapted to illuminate the fluorescent road markings adjacent to the first side boundary of the road;
a controller adapted to interface with the at least one proximity sensor and the at least one ultraviolet source of light adjacent to the first side boundary of the road, the controller adapted with a timer function to automatically turn on the at least one ultraviolet light source for a prescribed amount of time before turning it off;
a wireless communication means associated with the controller to transmit a signal to another controller on at least a second side boundary of the crosswalk; and
the signal received by the controller adjacent to the second side boundary of the crosswalk, the controller adapted to automatically turn on the at least one ultraviolet light source for a prescribed length of time and then turning it off.

13. The method of claim 12, wherein a button is in communication with the controller to manually activate the at least one ultraviolet light source for a prescribed amount of time before turning it off.

14. The method of claim 12, wherein the at least one ultraviolet light is configured to blink on and off.

15. The method of claim 12, wherein the at least one proximity sensor comprises of an ultrasonic emitter-detector.

16. The method of claim 12, wherein the at least one proximity sensor comprises of an infrared sensor.

17. The method of claim 12, wherein the wireless communication between controllers is RF-based.

18. The method of claim 12, wherein the controller comprises an ambient light detector to determine low-light conditions.

19. The method of claim 12, wherein the controller, the at least one proximity sensor, and the at least one ultraviolet sensor are partially disposed on at least one support pole.

20. The method of claim 12, wherein the power source for the controller, the at least one proximity sensor, and the at least one ultraviolet light source is a solar array with rechargeable battery.
